(19) United States
(12) Patent Application Publication
(10) Pub. No.: US 2009/0030815 A1
(43) Pub. Date: Jan. 29, 2009

(54) ENVIRONMENT-IMPACTING MEMBER PURCHASE DEVICE AND ENVIRONMENT-IMPACTING MEMBER PURCHASE SYSTEM

(76) Inventor: Sakuo Shimizu, Osaka (JP)

Correspondence Address: WENDEROTH, LIND & PONACK L.L.P., 2033 K. STREET, NW, SUITE 800, WASHINGTON, DC, 20006, US

(21) Appl. No.: 12/280,834

(22) PCT Filed: Mar. 9, 2007
(86) PCT No.: PCT/JP2007/054717

§ 371 Date: Aug. 27, 2008

(30) Foreign Application Priority Data
Mar. 10, 2006 (JP) 2006-066470

(51) Int. Cl. G06Q 30/00

(52) U.S. Cl. 705/27

(57) ABSTRACT

An environment-impacting member purchase system which enables efficient purchase of a member containing a specific chemical substance and the like while satisfying a purchaser's requirement is disclosed. A member specification specifying unit (150) of an environment-impacting member purchase device (101) specifies a member specification for conforming a to-be-purchased member to the environment standard. A request information generating unit (160) generates request information that indicates a proposal regarding the member is requested by using the member specification specified by the member specification specifying unit (150). A communication control unit (110) transmits the proposal request information generated by the request information generating unit (160) to a selling-side terminal (700) and the like. A member purchase judging unit (171) analyzes details of proposal response information received from the selling-side terminal (700) and the like and judges whether or not to adopt the proposal.

### TECHNICAL FIELD

The present invention relates to a communication system for purchasing a member, which is included in a product and the like, containing a chemical substance or an environment-impacting substance that are regulated by an environment standard and the like.

### BACKGROUND ART

Component selection systems have been conventionally proposed which allow automatically selecting an optimal component for use in designing a product and providing a designer with the component.

FIG. 1 is a block diagram illustrating a configuration of a conventional component selection system. In the conventional component selection systems as illustrated in FIG. 1, when component information of each component, which is provided by a terminal device 1000 of a component supplier, is given to a server device 2000, the component information of each component is stored in a data storage 2022 to generate a database. Further, a compatible condition table and a priority condition table are generated and stored in the data storage 2022, which respectively represent compatible conditions or priority conditions for selecting an optimal component that is optimal among components indicating the same characteristic as the component used in designing. Further in the system, when a selection of component is requested by a terminal device 3000 of a client, an optimal component is selected with reference to the database, the compatible condition table, and the priority condition table.

### Patent Reference 1: 2002-245093

### DISCLOSURE OF INVENTION

### Problems that Invention is to Solve

In recent years, however, as environmental issues have been emphasized, manufacturers are required to fulfill their social responsibilities in view of an environmental protection. More specifically, specific chemical substances or environment-impacting substances (hereinafter referred to as “chemical substance and the like”) which give burden to the environment have been banned from being used, imported, and manufactured, or their content rates in a product have been regulated by an ordinance such as laws and regulations.

Accordingly, establishing a more rigorous product specification and more detailed information on components and the like are required for observing the laws. However, the conventional member selection systems pose a problem that it is difficult to satisfy the requirements described above.

To be specific, it is difficult to specify the components or materials (hereinafter referred to as “member”) that conflict with the environment standard and to specify these members in a product. Further, whether or not the proposal details from a distributor of a member is suitable to the environment standard is unknown in some cases, making it impossible to efficiently purchase the member and sufficiently collect necessary information when purchasing the member, thereby making the situation inefficient.

The present invention has been conceived in view of the above-described problems, and has a first object to provide an environment-impacting member purchase system which enables efficient purchase of a member and the like containing a specific chemical substance and the like while satisfying a purchaser's requirement. Further, the present invention has a second object to provide an environment-impacting member purchase system which enables efficient purchase of a member and the like containing a chemical substance that is regulated by the environment standard and the like while satisfying a purchaser's requirement.

### Means to Solve the Problems

An environment-impacting member purchase device according to the present invention communicates with a selling-side terminal of a distributor in order to purchase a member containing a chemical substance or an environment-impacting substance that are regulated by an environment standard and the device includes: a member specification specifying unit that specifies a member specification for conforming a member to be purchased to the environment standard; a request information generating unit that generates request information that indicates requesting for a proposal regarding the member by using the specified member specification; and a proposal request transmission unit that transmits the generated proposal request information to the selling-side terminal.

This enables an efficient purchase of a member in which a specific chemical substance and the like is included while satisfying a purchaser's requirement.

Further, the environment-impacting member purchase device according to the present invention narrows down candidates for a seller from which a member or a product is purchased, or determines the seller, the member or the product containing a chemical substance or an environment-impacting substance that are regulated by an environment standard, and the device includes: a member specification specifying unit that specifies a member specification for conforming a member to be purchased to the environment standard; a request information generating unit that generates proposal request information that indicates requesting for a proposal regarding the member by using the specified member specification; a communication control unit that transmits the generated proposal request information to a plurality of selling-side terminals, and to receive, from the plurality of selling-side terminals, proposal response information that is a response to the proposal request information, the proposal response information including predetermined to-be-judged details; and a member-purchase judging unit that: evaluates, based on a criterion specified for each of judgment items, the to-be-judged details of the received proposal response information; and narrows down candidates for the seller of the member or determine the seller based on a result of the evaluation.

This enables an efficient purchase of the member described above, even in the case where an environment standard such as a law or company standards are revised, while flexibly and exactly responding to the revision.

Further, the member-purchase judging unit makes the proposal response information belong to one of predetermined evaluation zones by using the result of the evaluation, counts the number of pieces of proposal response information in the evaluation zones, changes the criterion based on a result of the count, and narrows down the candidates for the seller of the member or determines the seller by using the changed criterion.

This enables more carefully determining a seller, a receiver of a proposal reintroduction request, or rejection.

It is to be noted that the present invention can also be implemented as an integrated circuit including characteristic components that the above-described environment-impacting member purchase device includes, and as a method for purchasing environment-impacting member including the characteristic components as steps. Further, the present invention can also be implemented as a program which causes a computer and the like to execute the steps described above. It is to be understood that such a program can be widely distributed via a recording medium such as a DVD and a transmission medium such as the Internet.

Furthermore, the present invention can also be implemented as an environment-impacting member purchase system in which the above-described environment-impacting member purchase device and a selling-side terminal are provided.

### EFFECTS OF THE INVENTION

The present invention makes it possible to efficiently purchase a member containing a specific chemical substance and the like while satisfying a purchaser's requirement. Further, the present invention makes it possible to efficiently purchase a member containing a chemical substance and the like that is regulated by the environment standard and the like while satisfying a purchaser's requirement. Furthermore, the present invention makes it possible, even in the case where the environment standard such as an ordinance or a company standard is revised, to flexibly and exactly respond to the above-described revision and to more carefully determine: a seller; a receiver of a proposal reintroduction request; or rejection, according to the proposal from a distributor of the member.

### BRIEF DESCRIPTION OF DRAWINGS

FIG. 1 is a block diagram illustrating a configuration of a conventional member selection system.

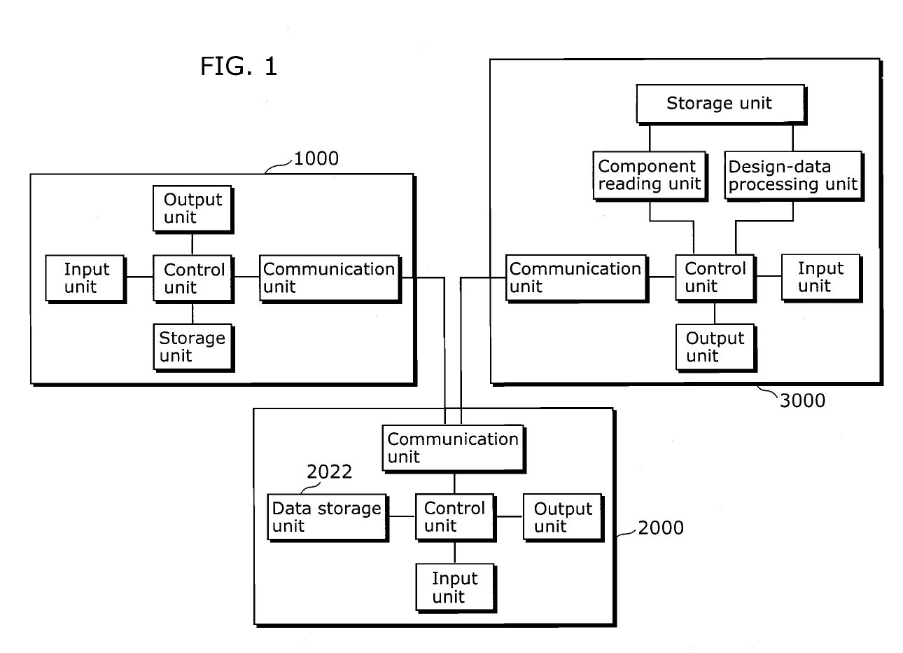

FIG. 2 is a block diagram illustrating an example of a configuration of an environment-impacting member purchase system according to a first embodiment.

FIG. 3 is a block diagram illustrating a functional configuration of an environment-impacting member purchase device according to the first embodiment.

FIG. 4 is a block diagram illustrating a functional configuration of a selling-side terminal according to the first embodiment.

FIG. 5 is a diagram illustrating an example of a member information table that is stored in a member information DB according to the first embodiment.

FIG. 6 is a diagram illustrating an example of a member proposal information table that is stored in a member proposal information DB according to the first embodiment.

FIG. 7 is a flowchart illustrating an operational flow of the environment-impacting member purchase system according to the first embodiment.

FIG. 8 is a flowchart illustrating details of adoption judgment processing 1 according to the first embodiment.

FIG. 9 is a flowchart illustrating an operational flow in the case where a distributor voluntarily transmits proposal response information to a purchaser according to the first embodiment.

FIG. 10 is a diagram illustrating an example of a display on an output unit of the environment-impacting member purchase device according to the first embodiment.

FIG. 11 is a diagram illustrating an example of proposal request information displayed on an output unit of a selling-side terminal according to the first embodiment.

FIG. 12 is a diagram illustrating an example of proposal response information displayed on an output unit of an environment-impacting member purchase device according to the first embodiment.

FIG. 13 (a) is a diagram illustrating an example of a criterion table used when evaluating each judgment item described in the received proposal response information according to a second embodiment. FIG. 13 (b) is a diagram illustrating an example of an evaluation result according to the second embodiment.

FIG. 14 is a flowchart illustrating an operational flow of the environment-impacting member purchase system according to the second embodiment.

FIG. 15 is a flowchart illustrating details of adoption judgment processing 2 according to the second embodiment.

FIG. 16 is a pattern diagram illustrating a process of an earlier stage in FIG. 14 described above.

FIG. 17 is a diagram illustrating an example of proposal request information displayed on an output unit of a selling-side terminal according to the second embodiment.

FIG. 18 is a diagram illustrating an example of proposal response information displayed on an output unit of an environment-impacting member purchase device according to the second embodiment.

FIG. 19 is a pattern diagram illustrating a process of a later stage in FIG. 14 described above.

FIG. 20 (a) is a diagram illustrating an example of a criterion table used when evaluating each judgment item described in the received proposal response information according to a third embodiment. FIG. 20 (b) is a diagram illustrating an example of an evaluation result according to the third embodiment.

FIG. 21 is a flowchart illustrating details of adoption judgment processing 2 according to the third embodiment.

### NUMERICAL REFERENCES

11, 12, 13 environment-impacting member purchase system
15, 16, 17 purchaser system
101, 102, 103 environment-impacting member purchase device
110 communication control unit
120 network control unit
130 target member searching unit
140 target member specifying unit
150 member specification specifying unit
160 request information generating unit
171, 172, 173 member purchase judging unit
200, 201, 202, 203 purchaser terminal (in an establishment)
210 operation input unit
220 output unit
270 member information DB
280 environment standard information DB
290 member proposal information DB
300, 301 purchaser terminal (outside an establishment)
600 Internet
700, 800, 900 selling-side terminal
710 communication control unit
720 environment standard obtainment unit
730 request information analysis unit
740 proposal member specifying unit
750 proposal information generating unit
760 proposal member searching unit
770 operation input unit
780 output unit

### BEST MODE FOR CARRYING OUT THE INVENTION

Best mode for carrying out the present invention will be described below with reference to the drawings. Note that, although the present invention will be described with following embodiments and the drawings, they are intended not for the purpose of limitation but for exemplification only.

### FIRST EMBODIMENT

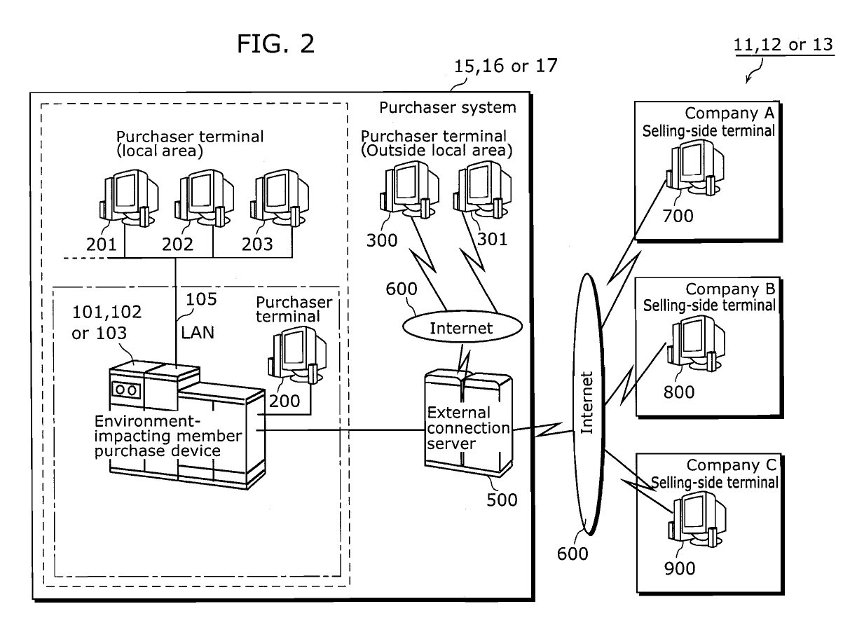

FIG. 2 is a block diagram illustrating an example of a configuration of an environment-impacting member purchase system 11 according to the present embodiment. As illustrated in FIG. 2, the environment-impacting member purchase system 11 is a communication system for purchasing a member including a chemical substance and the like that are regulated by the environment standard such as laws, company standards, and the like, and a purchaser system 15 of a purchaser of the above-described member (for example, a manufacture of picture equipments) is connected, via the Internet 600, to a selling-side terminal 700, a selling-side terminal 800, and a selling-side terminal 900 (hereinafter collectively referred to as “selling-side terminals 700”) of a company A, a company B, and a company C, respectively, each of which is a distributor of the member (for example, a component distributor). Further, the purchaser system 15 includes: an external connection server 500; an environment-impacting member purchase device 101 provided with a purchaser terminal 200 and the like; and purchaser terminals 200 to 203, 300 and 301 (hereinafter collectively referred to as “purchaser terminals 200”). It is to be noted that the environment-impacting member purchase device 101, the purchaser terminals 200, 201, and 202 are in a specific establishment and the purchaser terminals 300 and 301 are outside the establishment and may be connected to the external connection server 500 via the Internet 600.

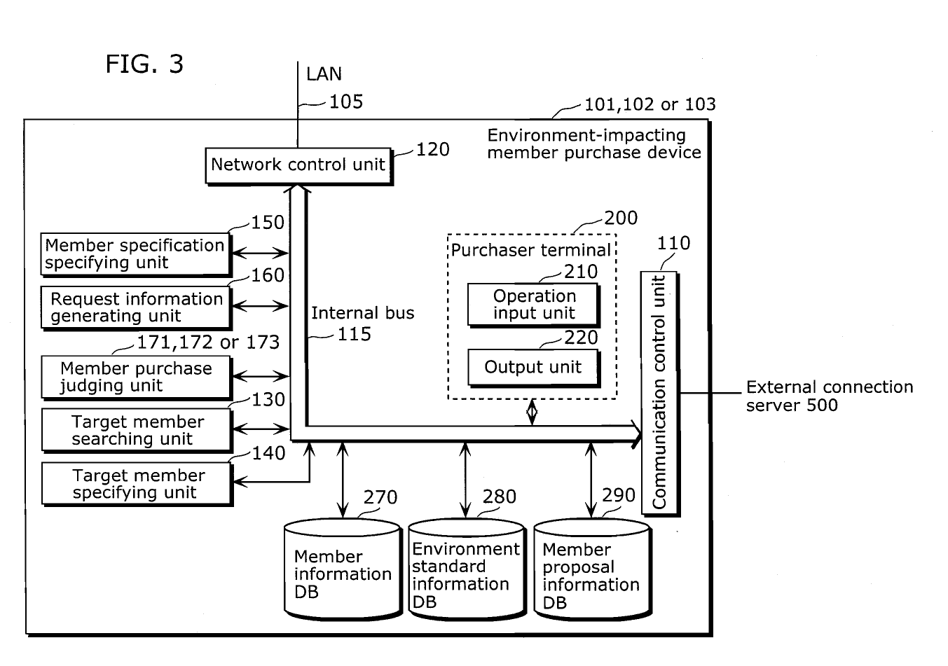

FIG. 3 is a block diagram illustrating a functional configuration of the environment-impacting member purchase device 101 according to the present embodiment. As illustrated in FIG. 3, the environment-impacting member purchase device 101 includes: the purchaser terminal 200; a communication control unit 110; a network control unit 120; a target member searching unit 130; a target member specifying unit 140; a member specification specifying unit 150; a request information generating unit 160; a member purchase judgment unit 171; a member information DB 270; an environment standard information DB 280; and a member proposal information DB 290, each of them being connected with each other via an internal bus 115. It is to be noted that the purchaser terminal 200 includes an operation input unit 210 and an output unit 220.

The communication control unit 110 is a microcomputer provided, for example, with a RAM, a ROM that stores control programs, and a dedicated processor for communication controls, and controls entirely the environment-impacting member purchase device 101. Further, the communication control unit 110 controls communication with the selling-side terminals 700 via the external connection server 500 and the Internet 600. More specifically, the communication control unit 100 receives proposal response information transmitted by the selling-side terminals 700 as well as transmitting proposal request information generated by the request information generating unit 160 to the selling-side terminals 700.

The network control unit 120 controls communication between the environment-impacting member purchase device 101 and the purchaser terminals 201, 202, and 203 via the LAN 105.

The target member searching unit 130 searches a candidate of a member to be purchased according to an instruction from a user which is received via the operation input unit 210 of the purchaser terminal 200.

The target member specifying unit 140 specifies the member to be purchased, from among candidates of the member to be purchased, according to an instruction from a user which is received via the operation input unit 210.

The member specification specifying unit 150 obtains an environment standard under the law and an environment standard in the company, according to an instruction from a user which is received via the operation input unit 210. Further, the member specification specifying unit 150 specifies, regarding the member specified by the target member specifying unit 140, whether or not the environment standard to be applied has been changed and a specification of a member of the target member (this is referred to as “member specification”) so as to conform to the environment standard (or, specifies according to the instruction by the user), by referring to the member information DB 270 and the environment standard information DB 280.

The request information generating unit 160 generates, by using the specified member specification, proposal request information that indicates a proposal regarding the member is requested.

The member purchase judging unit 171 analyzes details of the proposal response information received from the selling-side terminals 700 and judges whether or not to adopt the proposal.

The member information DB 270 is a hard disc device, for example, and stores: information regarding the member composing each product (for example, a member name, a member number, and the like) per product unit (products are identified according to a product number or a product name); and information regarding a chemical substance and the like contained in each of the member (for example, a chemical substance name, a CAS number (also referred to as “CAS registration number”), a content rate, and a chemical substance group name to which the chemical substance belongs). Here, the CAS number is a number assigned for identifying a chemical substance by the CAS (Chemical Abstracts Service) by the American Chemical Society and substances having the same CAS number are regarded as the same substance even when having different names.

The environment standard information DB 280 is a hard disc device, for example, and stores the environment standard under the law or the environment standard specified in the company of the purchaser per environment standard name unit.

The member proposal information DB 290 is a hard disc device, for example, and stores the information regarding the member composing each product (for example, the member name, the member number, and the like) per product unit, and information regarding the chemical substance and the like contained in each of the member (for example, the chemical substance name, the CAS number, the content rate, and the chemical substance group name to which the chemical substance belongs).

The operation input unit 210 of the purchaser terminal 200 is a keyboard or a mouse, for example, and receives an instruction from the user and informs the communication control unit 110. Further, the output unit 220 of the purchaser terminal 200 is a liquid crystal panel, for example, and presents necessary information to the user.

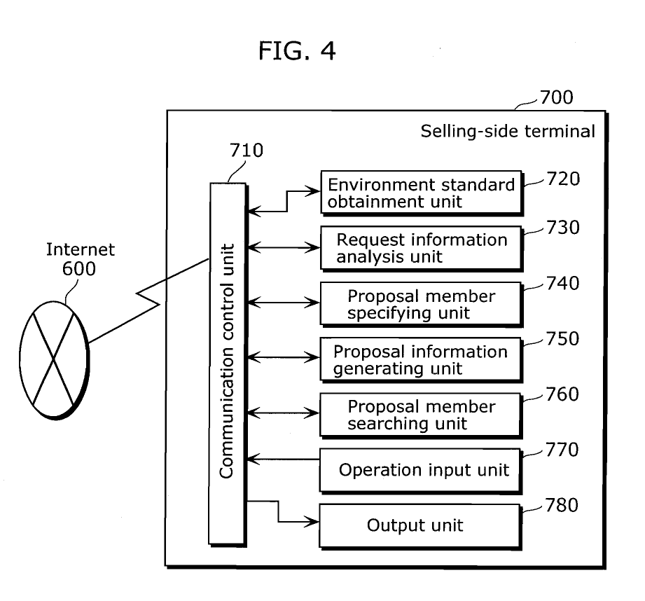

FIG. 4 is a block diagram illustrating a functional configuration of the selling-side terminal 700 of the company A according to the present embodiment. As illustrated in FIG. 4, the selling-side terminal 700 is a terminal that newly proposes a member to the environment-impacting member purchase device 101 by using a communication function, and includes: a communication control unit 710; a environment standard obtainment unit 720; a request information analysis unit 730; a proposal member specifying unit 740; a proposal information generating unit 750; a proposal member searching unit 760; an operation input unit 770 and an output unit 780. It is to be noted that the selling-side terminal 800 of the company B and the selling-side terminal 900 of the company C are assumed to have the same functional configuration as the above-described selling-side terminal 700.

The communication control unit 710 is a microcomputer provided, for example, with a RAM, a ROM that stores control programs, and a dedicated processor for communication controls, and controls entirely the selling-side terminal 700. More specifically, the communication control unit 710 receives proposal request information transmitted by the environment-impacting member purchase device 101 as well as transmitting proposal response information that is a response to the proposal request information to the environment-impacting member purchase device 101.

The environment standard obtainment unit 720 obtains environment standard by the law according to an instruction from a user (and further obtains the environment standard in the company of the purchaser in the case where obtainment is possible by accessing to the Internet website, and the like).

The request information analysis unit 730 analyzes the proposal request information received from the environment-impacting member purchase device 101 and specifies to-be-proposed details (for example, a specification to be changed for a member to be purchased).

The proposal member specifying unit 740 specifies, from among members of the company A, the member optimal to propose according to a search result of the proposal member searching unit 760.

The proposal information generating unit 750 generates the proposal response information, according to the instruction from the user which is received via the operation input unit 770, by adding necessary information to the proposal request information received from the environment-impacting member purchase device 101.

The proposal member searching unit 760 analyzes the proposal request information received from the environment-impacting member purchase device 101 and searches a to-be-proposed candidate member of the company A.

The operation input unit 770 is a keyboard or a mouse, for example, and receives the instruction from the user and informs the communication control unit 710. Further, the output unit 780 is a liquid crystal panel, for example, and presents the necessary information to the user.

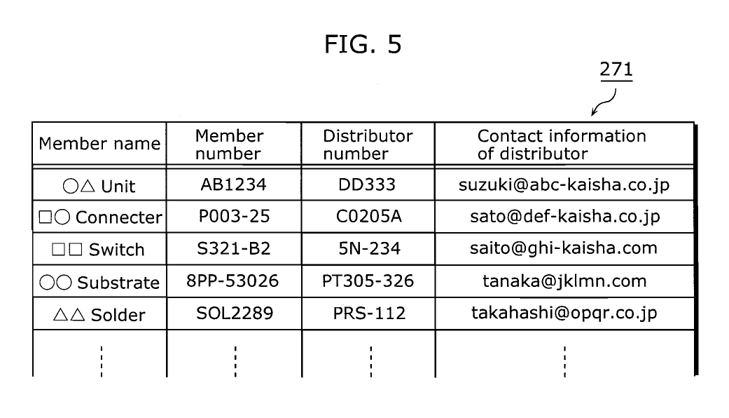

FIG. 5 is a diagram illustrating an example of a member information table that is stored in the member information DB. Information such as a member number, a distributor number, contact information of a distributor, and so on is stored in a member information table 271 in association with each of the members as illustrated in FIG. 5.

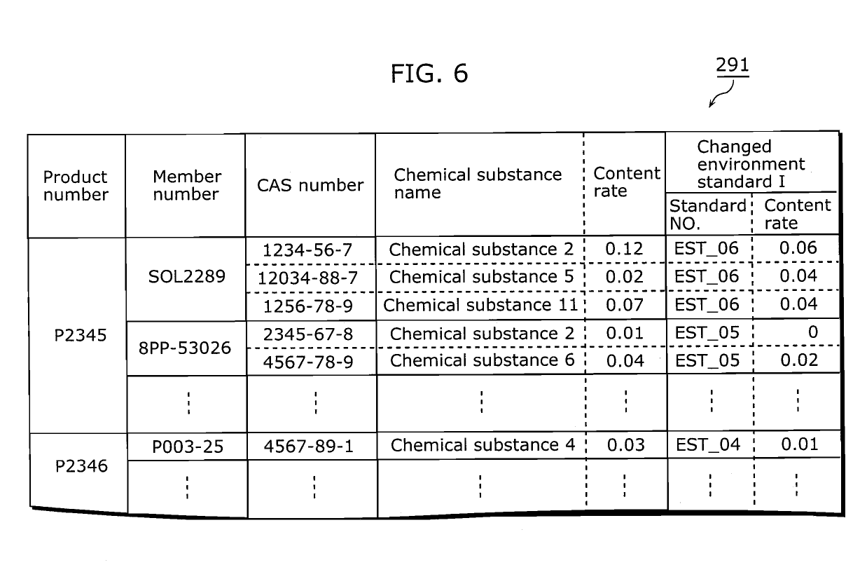

FIG. 6 is a diagram illustrating an example of a member proposal information table that is stored in the member proposal information DB 290. Information including a member number, a chemical substance name, a CAS number, a content rate, information indicating the details of changed environment standard (for example, a standard No. and a content rate), is stored in a member proposal information table 291 in association with each product numbers as illustrated in FIG. 6.

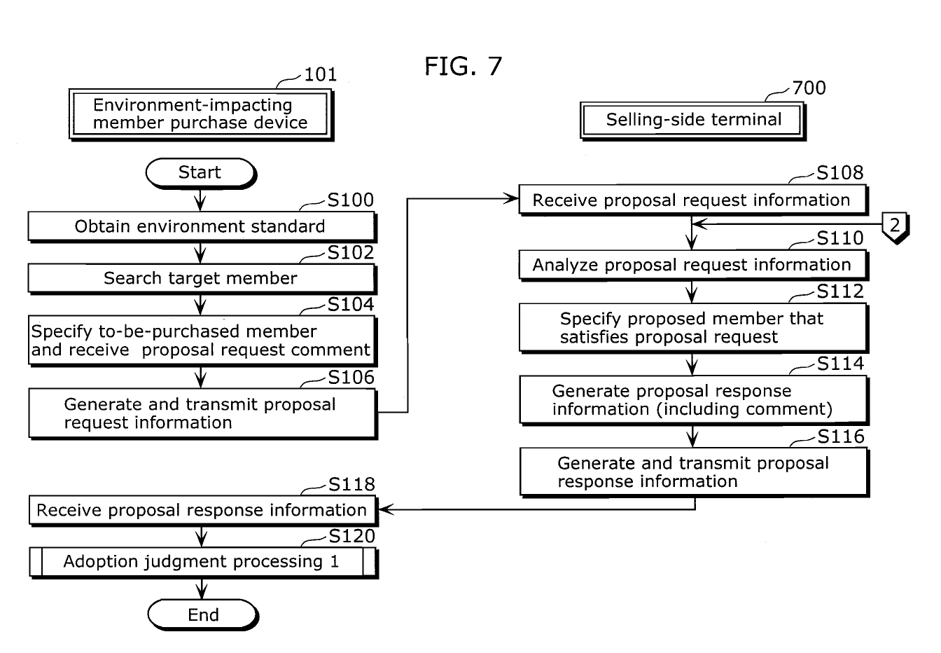

Next, operations in the environment-impacting member purchase system 11 configured as described above will be described. FIG. 7 is a flowchart illustrating an operational flow of the environment-impacting member purchase system 11 according to the present embodiment.

First, the environment-impacting member purchase device 101 obtains a new environment standard or a revised environment standard (S101), and searches a target member to which the environment standard is applied (S102). Next, the environment-impacting member purchase device 101 specifies, from among a search result, a to-be-purchased member, the environment standard to be applied, and the like and receives a comment to be attached to proposal request information (S104) from a user via the operation input unit 210. Further, the environment-impacting member purchase device 101 generates the proposal request information to which the comment is attached and transmits the proposal request information to the selling-side terminals 700 (S106).

Next, the selling-side terminal 700, when receiving the proposal request information from the environment-impacting member purchase device 101 (S108), analyzes the details of the proposal request information (S110), and specifies the member that satisfies the specification described in the proposal request information (112). Further, the selling-side terminal 700 generates proposal response information (including the comment) that is a response to the proposal request information (S114), and transmits the proposal response information to the environment-impacting member purchase device 101 (S116).

Subsequently, the environment-impacting member purchase device 101, when receiving the proposal response information from the selling-side terminal 700 (S118), performs adoption judgment processing 1 for the proposal response information (S120).

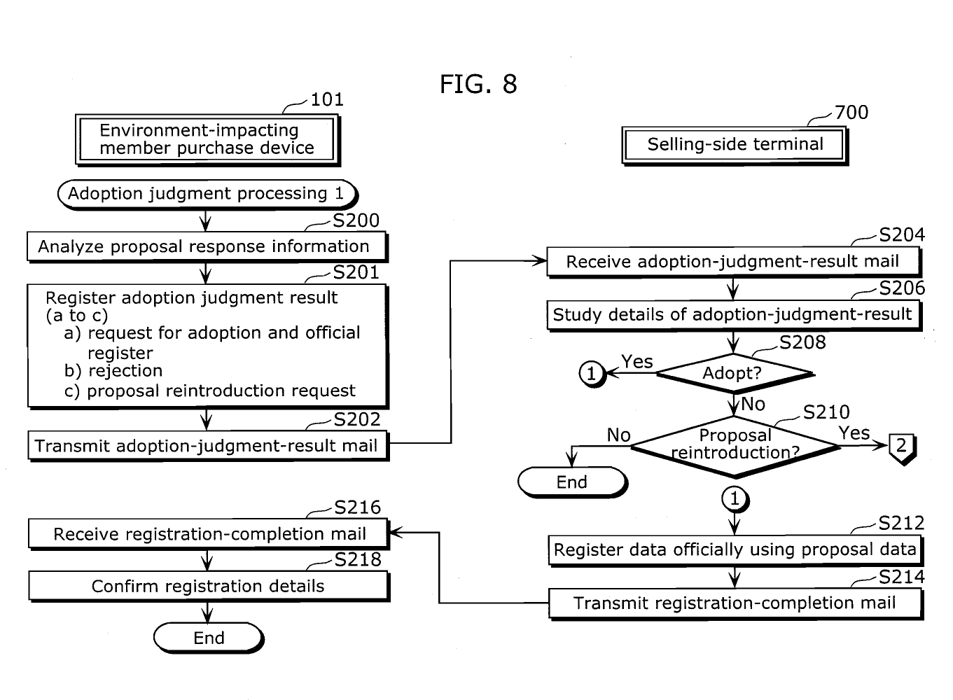

FIG. 8 is a flowchart illustrating details of the adoption judgment processing 1 (S120) in the above-described FIG. 7.

First, the environment-impacting member purchase device 101 analyzes the details of the proposal response information that has been received (S200), judges whether or not to adopt the proposal, and determines on one of a) request for adoption and official register, b) rejection, and c) proposal reintroduction request (S201). Subsequently, the environment-impacting member purchase device 101 informs the selling-side terminal 700 of an adoption-judgment-result mail indicating the determined details (S202).

The selling-side terminal 700, when receiving the adoption-judgment-result mail from the environment-impacting member purchase device 101 (S204, S206), performs operations necessary for the official registration (S212 to S218) or the proposal reintroduction (S210) (or ends the processing).

It is to be noted that, in the above-described FIG. 7, although an embodiment in which the proposal response information is transmitted from the distributor in response to the proposal request information that has been received from the purchaser, the proposal response information may be transmitted to the purchaser voluntarily from the distributor (without receiving the proposal request information).

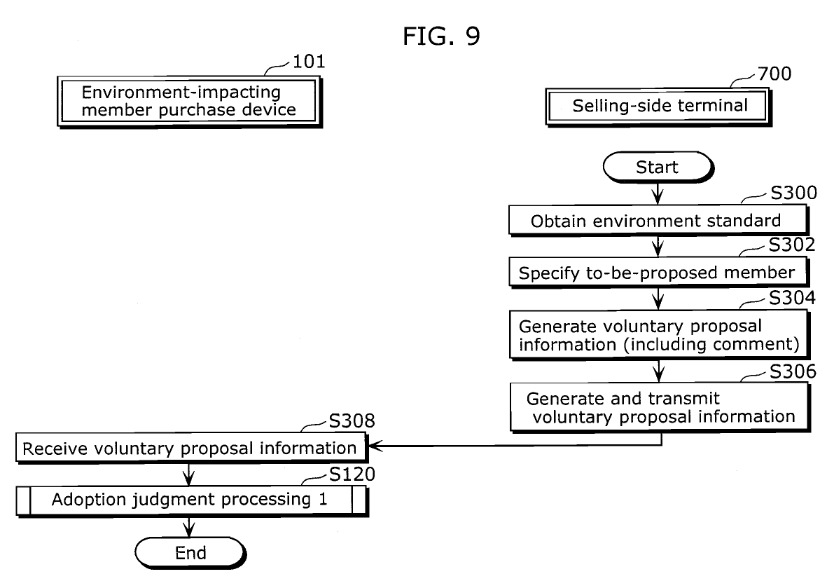

FIG. 9 is a flowchart illustrating an operational flow in the case where the distributor voluntarily transmits proposal response information to the purchaser.

First, the selling-side terminal 700 obtains a new environment standard or a revised environment standard (S300), and specifies a to-be-proposed target member to which the environment standard is applied to the environment-impacting member purchase device 101 (S302). Next, the selling-side terminal 700 generates proposal response information (including the comment) that indicates voluntary proposal details (S304), and transmits the proposal response information to the environment-impacting member purchase device 101 (S306).

The environment-impacting member purchase device 101, when receiving the voluntary proposal information from the selling-side terminal 700 (S308), performs the adoption judgment processing 1 for the voluntary proposal information that has been received (S120). It is to be noted that, in the adoption judgment processing 1 (S120), the same processes as in the case of FIG. 8 as described above are performed, other than analyzing the voluntary proposal information in place of proposal response information.

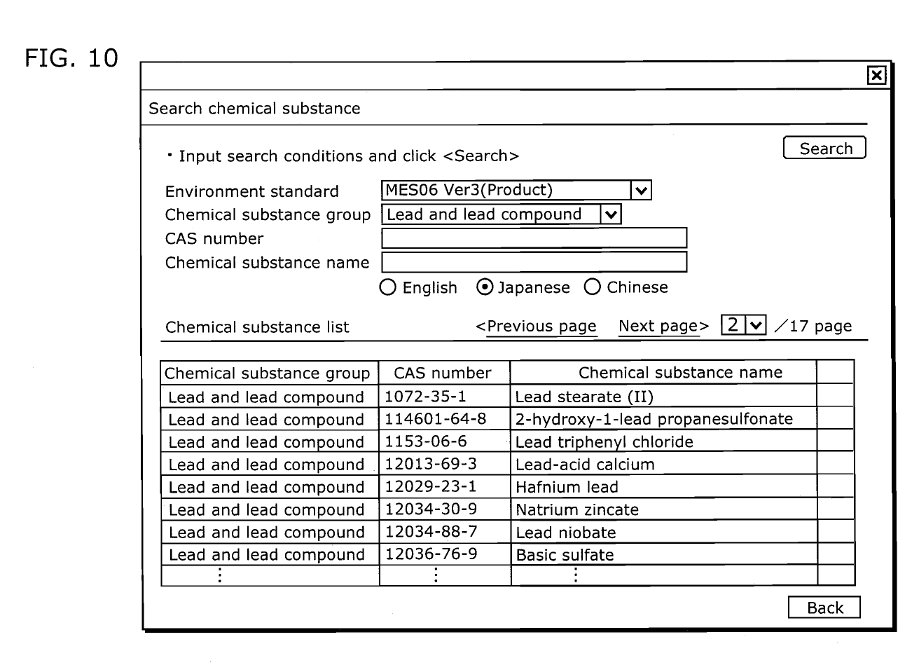

FIG. 10 is a diagram illustrating an example of a display on the output unit 220 of the environment-impacting member purchase device 101 according to the present embodiment. FIG. 10 is an example of a search result in the case where a search has been carried out by specifying an “environment standard name” and a “chemical substance group name”.

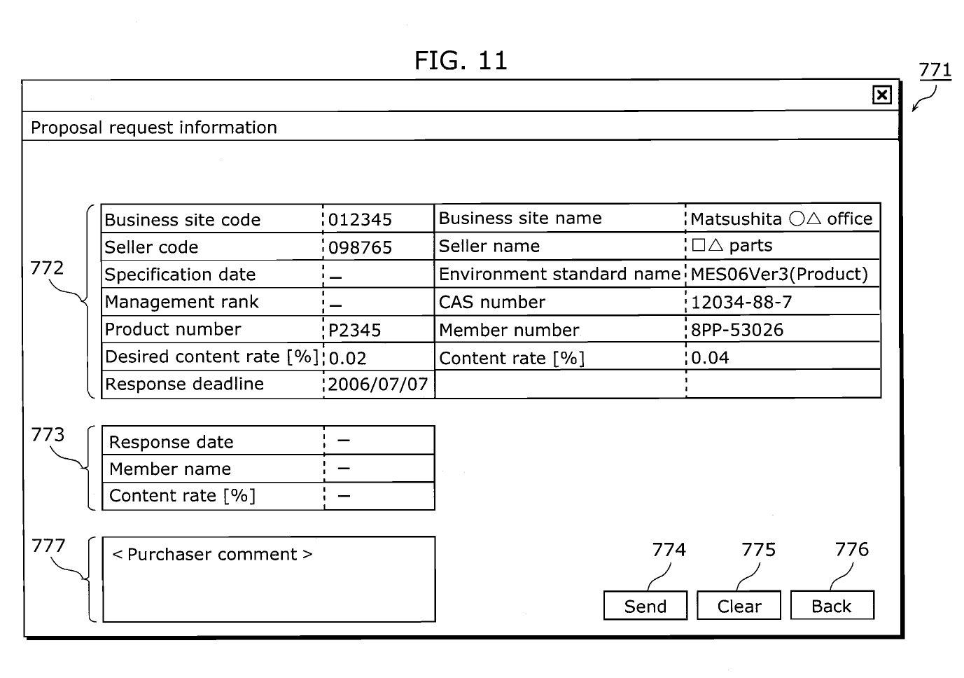

FIG. 11 is a diagram illustrating an example of proposal request information displayed on an output unit 780 of the selling-side terminal 700 according to the present embodiment. Information 772 specified by a purchaser and information 773 to be entered by a distributor is indicated in FIG. 11 (in the case of FIG. 11, “-” that indicates no entry is illustrated since the proposal request information has just been received).

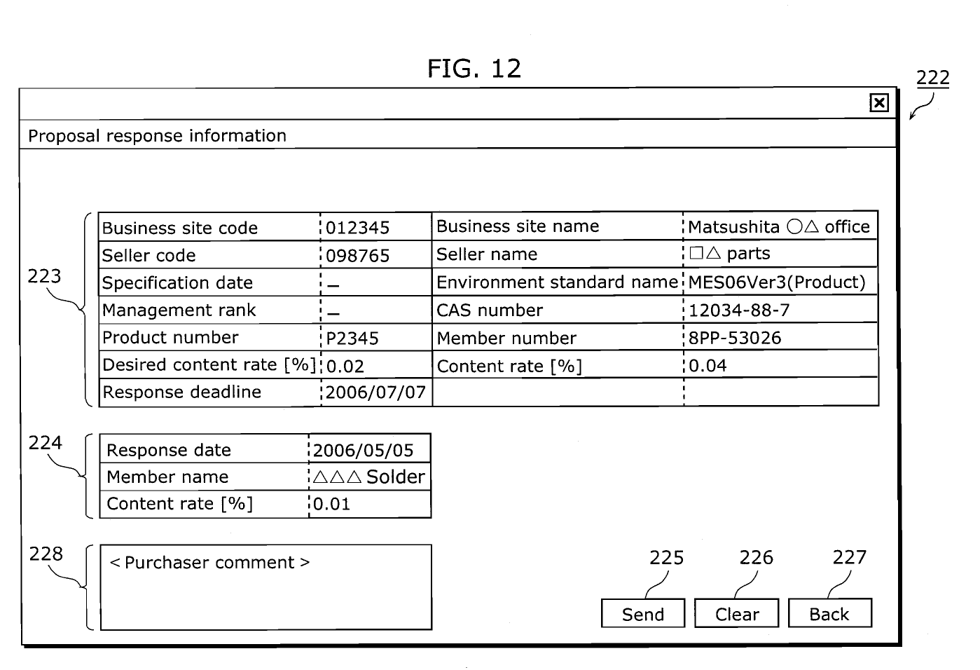

FIG. 12 is an example of the proposal response information displayed on the output unit 220 of the environment-impacting member purchase device 101 according to the present embodiment. In FIG. 12, Information 224 that has been entered by a distributor (unlike the information 773 in the above-described FIG. 11, the proposed details are described) is indicated.

As has been described above, the environment-impacting member purchase system of the present invention makes it possible to efficiently purchase a member containing a specific chemical substance and the like while satisfying a purchaser's requirement. Further, the present invention makes it possible to efficiently purchase a member containing a chemical substance and the like that is regulated by the environment standard and the like while satisfying a purchaser's requirement.

### SECOND EMBODIMENT

In the first embodiment described above, the environment-impacting member purchase system for purchasing a member including a chemical substance and the like that are regulated by environment standard such as the law or a company standard has been described. In the present embodiment, descriptions will be further given as to an environment-impacting member purchase system that makes it possible to efficiently purchase the above-described member, even in the case where the environment standard such as the law or the company standards are revised, while flexibly and exactly responding to the revision. It is to be noted that the functional configuration of the environment-impacting member purchase system according to the present embodiment is basically the same as in the environment-impacting member purchase system 11 according to the first embodiment described above, and thus descriptions hereafter will be focused on the characteristic functional configuration in the system.

A configuration example of an environment-impacting member purchase system 12 according to the present embodiment is illustrated in the above-described FIG. 2. The environment-impacting member purchase system 12 is the same as the above-described environment-impacting member purchase system 11 except for including an environment-impacting member purchase device 102 in place of the environment-impacting member purchase device 101 of the above-described environment-impacting member purchase system 11. It is to be noted that a purchaser system 16 of the environment-impacting member purchase system 12 is the same as the above-described purchaser system 15 except for including an environment-impacting member purchase device 102.

A configuration example of the environment-impacting member purchase device 102 is illustrated in the above-described FIG. 3. The environment-impacting member purchase device 102 is the same as the above-described environment-impacting member purchase device 101 except for including a member purchase judging unit 172 in place of the member purchase judging unit 171 of the above-described environment-impacting member purchase device 101.

The member purchase judging unit 172 evaluates to-be-judged details in proposal response information received from a selling-side terminal of a distributor who is a candidate seller based on a criterion specified for each of the judgment items, and, according to the evaluation result, narrows down candidates for the seller of the above-described member or determines finally the seller.

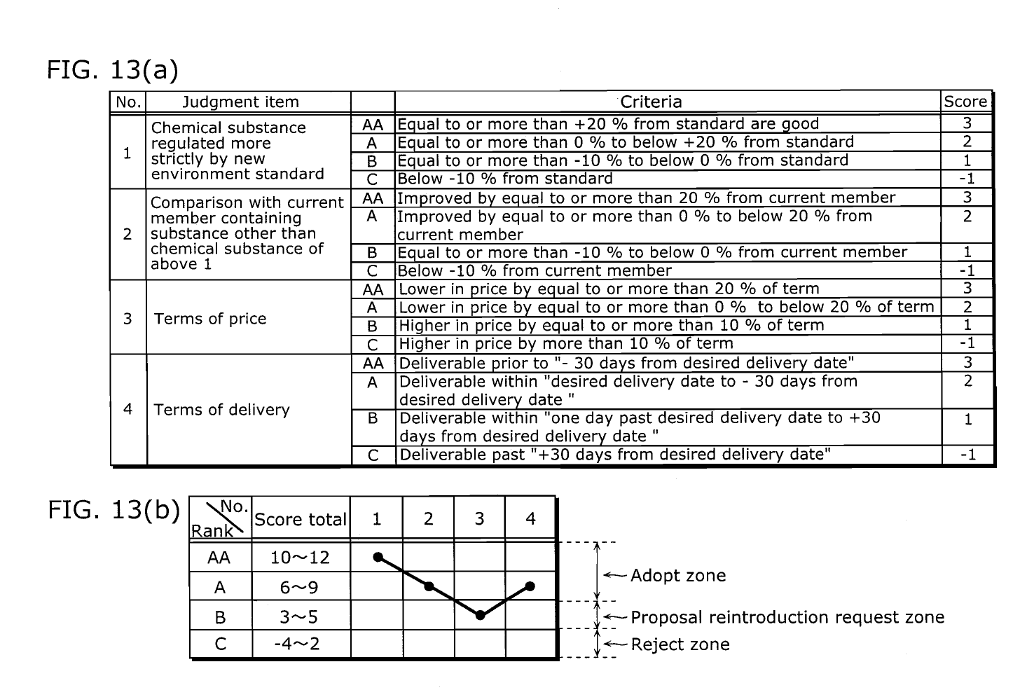

Next, a function of the member purchase judging unit 172 according to the present embodiment will be descried in detail with reference to FIG. 13. FIG. 13 (a) is a diagram illustrating an example of a criterion table that is used when the member purchase judging unit 172 evaluates each of the to-be-judged details described in the received proposal response information in order to narrow down distributors of the member. As illustrated in FIG. 13 (a), a “rank”, a “criterion”, and a “score” are defined in association with each other for each of the judgment items in the criterion table.

In the case of the judgment item No. 1 “a chemical substance regulated more strictly by the new environment standard” (it is assumed here, for convenience, that the environment standard for “lead content rate” in “solder” is “1% content rate”.), for example, in the case of “0.8% content rate”, equal to or more than 20% are good, and thus “AA rank” and “score=3” are obtained. Evaluation in the same manner can be carried out, and “comparison with the existing member containing a substance other than the chemical substance of 1 as described above”, “terms of price”, and “terms of delivery” as described in the received proposal response information are evaluated. It is to be noted that the judgment items are not limited to the four items described above, but may also be “minimum delivery amount”, “volume”, “weight”, and the like of the member.

FIG. 13 (b) is a diagram illustrating an example of the evaluation result of the member purchase judging unit 172. FIG. 13 (b) illustrates an example of the evaluation result regarding a company A (more specifically, the judgment items 1 to 4 regarding the proposal response information transmitted from the selling-side terminal 700), and a rank of each evaluation item is indicated. As illustrated in FIG. 13 (b), in the case of a score total of “6 to 12” (in other words, “rank AA” and “rank A”), the proposal response information belongs to an “adopt zone”, in the case of a score total of “3 to 5” (in other words, “rank B”), the proposal response information belongs to an “proposal reintroduction request zone”, and in the case of a score total of “−4 to 2” (in other words, “rank C”), the proposal response information belongs to an “reject zone”. Accordingly, in the case of the company A, the score total is “8”, and thus belongs to “adopt zone”. Although the example of FIG. 13 as described above indicates the result of evaluating the company A, the same evaluation is carried out also for other distributors that have transmitted proposal response information.

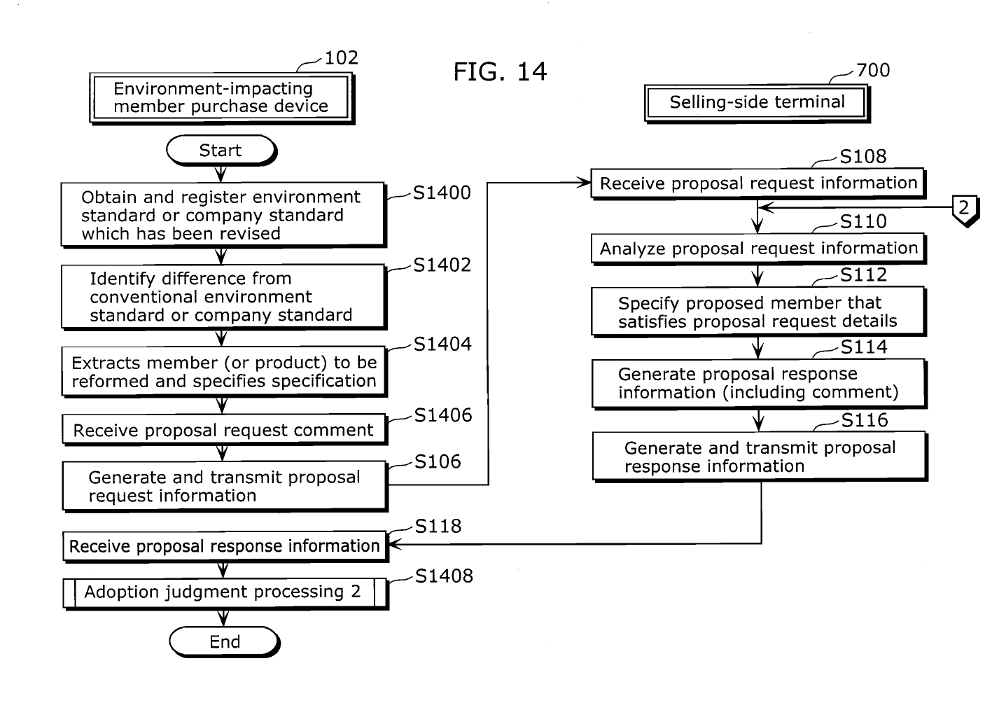

Next, descriptions will be given, with reference to FIG. 14 to FIG. 18, as to an operational flow in the environment-impacting member purchase system that is configured as described above. It is to be noted that the same numerals are applied to the same processes as in the above-described environment-impacting member purchase system 11 according to the first embodiment and the descriptions thereof are omitted.

FIG. 14 is a flowchart illustrating the operational flow in the environment-impacting member purchase system 12. It is to be noted that the same numerals are applied to the same processes as in the above-described environment-impacting member purchase system 11 according to the first embodiment and the descriptions thereof are omitted.

First, the environment-impacting member purchase device 102 obtains an environment standard or a company standard which has been revised (S1400), and compares the revised standard with the conventional environment standard or the company standard (S1402). Next, the environment-impacting member purchase device 102 extracts a member (or a product) to be reformed, and specifies the specification (S1404). Further, the environment-impacting member purchase device 102 receives a comment to be attached to proposal request information from a user via the operation input unit 210 (S1406). Further, the environment-impacting member purchase device 102 generates proposal request information to which the above-described comment is attached and transmits the proposal request information to the selling-side terminals 700 (S106).

Subsequently, the environment-impacting member purchase device 102, when receiving the proposal response information from the selling-side terminals 700 (S118), performs “adoption judgment processing 2” for the received proposal response information (S1408).

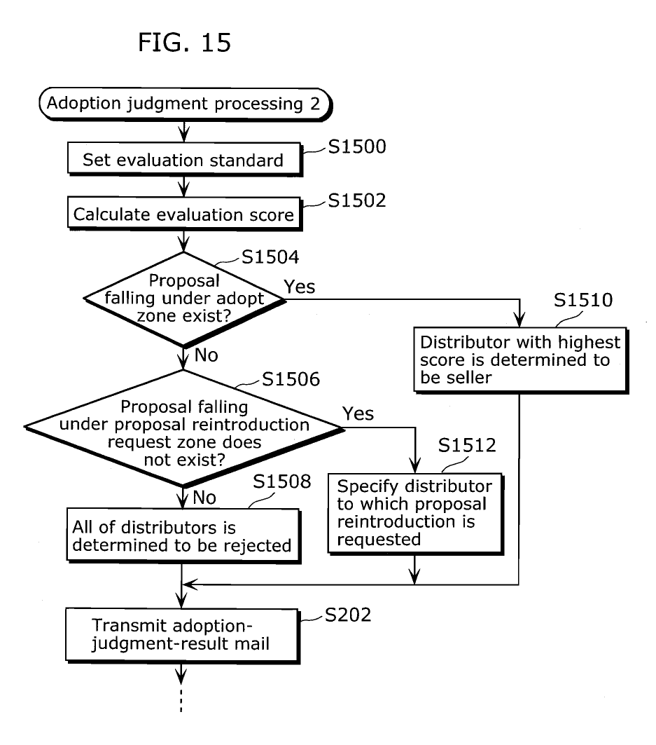

FIG. 15 is a flowchart illustrating details of the adoption judgment processing 2 (S1408) in the above-descried FIG. 14.

First, the member purchase judging unit 172 of the environment-impacting member purchase device 102 sets an evaluation standard (S1500), evaluates each of the to-be-judged details included in the received proposal response information, and calculates a total of a score (S1502). In the case where a distributor who has made a proposal that falls under the adopt zone exists according to the result (S1504: Yes), the distributor who has made the best proposal (in other words, the total score is the highest) is determined to be the seller (S1510).

On the other hand, in the case where a distributor who has made a proposal that falls under the adopt zone does not exist (S1504: No) and a distributor who has made a proposal that falls under the proposal reintroduction request zone does not exist either (S1506: No), all of the distributors who has transmitted the proposal response information is determined to be rejected (S1508). It is to be noted that a distributor who has made a proposal that falls under the proposal reintroduction request zone (S1506: Yes) is specified as a distributor to which proposal reintroduction is requested (S1512).

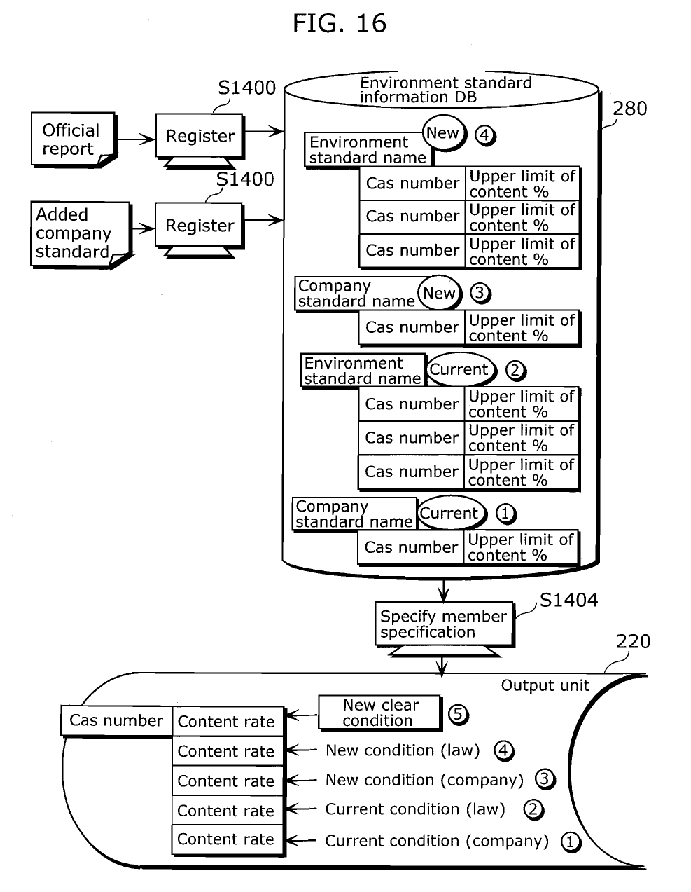

FIG. 16 is a pattern diagram illustrating a process of an earlier stage (S1400 to S1404) in FIG. 14 described above. After an official report or an added standard of the company is obtained and registered in the environment standard information DB 280 with a history attached (S1400), a specification for each member is specified (S1404).

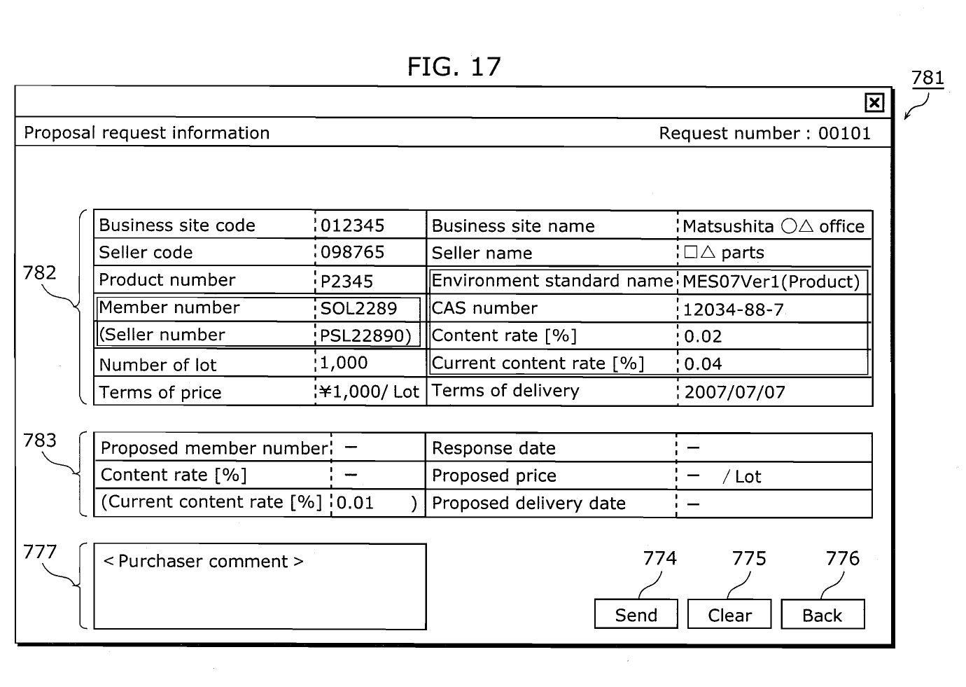

FIG. 17 is a diagram illustrating an example of proposal request information displayed on an output unit 780 of the selling-side terminal 700 according to the present embodiment. In FIG. 17, information 782 specified by the purchaser and information 783 to be entered by the distributor is indicated (in the case of FIG. 17, too, “-” that indicates no entry is illustrated since the proposal request information has just been received).

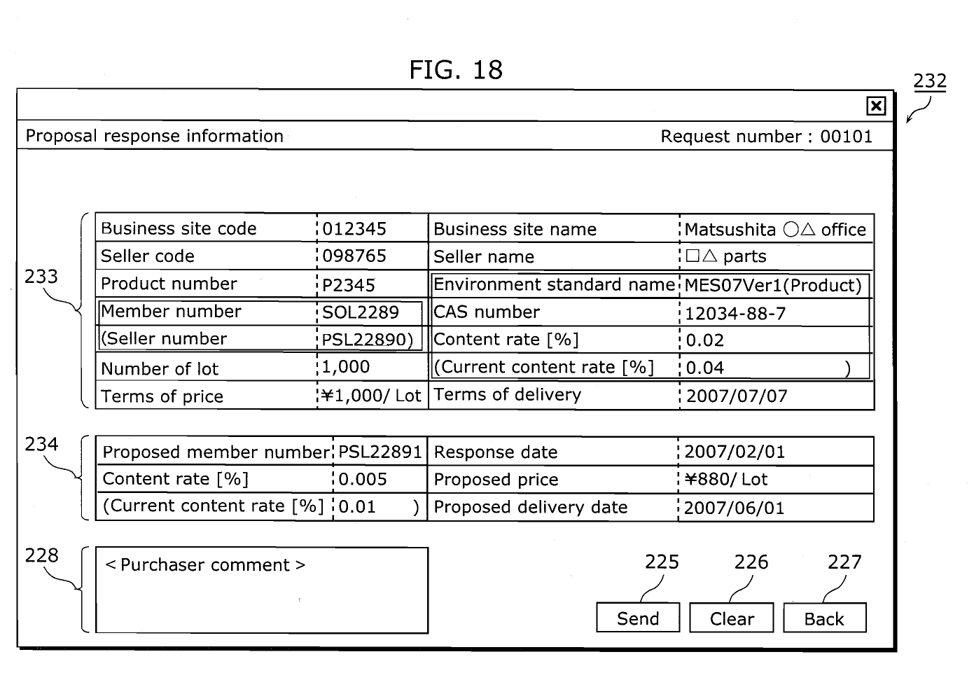

FIG. 18 is an example of the proposal response information displayed on the output unit 220 of the environment-impacting member purchase device 102 according to the present embodiment. In FIG. 18, Information 234 that has been entered by a distributor (unlike the information 783 in the above-described FIG. 17, the proposed details are indicated) is indicated.

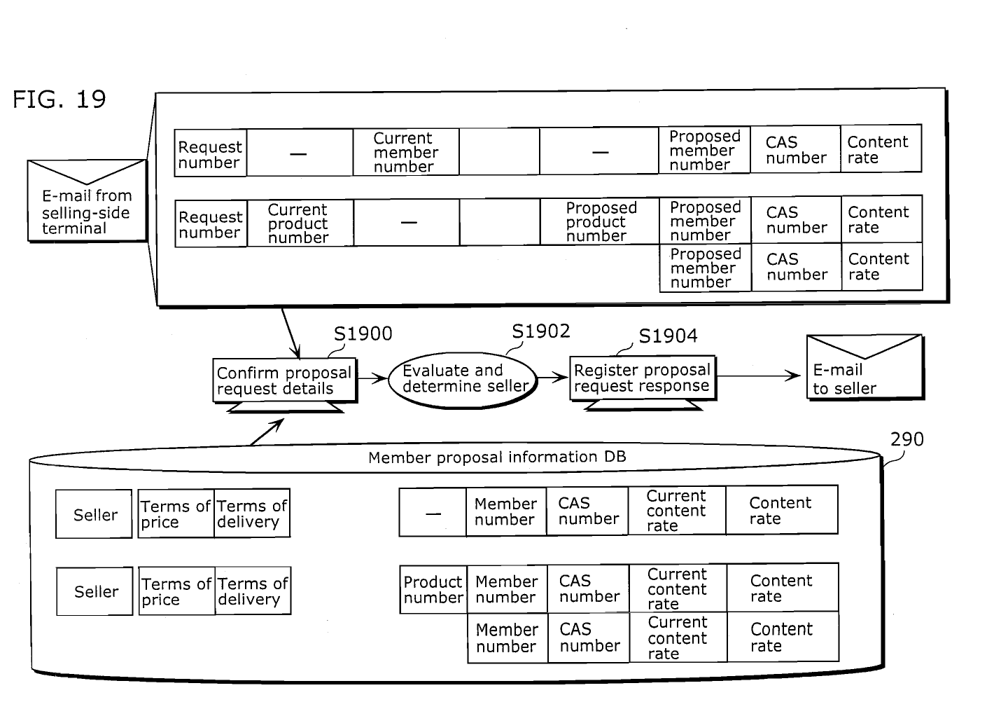

FIG. 19 is a pattern diagram illustrating a process of a later stage (S106 to S1408) in FIG. 14 described above. As illustrated in FIG. 19, when the proposal response information is received from the selling-side terminals 700 of each distributor, evaluation is performed for each of the to-be-judged details, and the result is sent to each of the selling-side terminals 700 as a response (S1900 to S1904).

As described above, a use of the environment-impacting member purchase system 12 provided with the environment-impacting member purchase device 102 according to the present embodiment makes it possible to efficiently purchase the above-described member, even in the case where the environment standard such as the law or the company standard is revised, while flexibly and exactly responding to the revision.

### THIRD EMBODIMENT

In the second embodiment described above, the environment-impacting member purchase system has been described which is capable of efficiently purchasing the above-described member even in the case where the environment standard such as the law or the company standard is revised while flexibly and exactly responding to the revision. In the present embodiment, descriptions will be further given as to an environment-impacting member purchase system that makes it possible to more carefully determine, according to the proposal from a distributor of the member, a seller, a receiver of a proposal reintroduction request, or a rejection. It is to be noted that the functional configuration of the environment-impacting member purchase system according to the present embodiment is basically the same as in the environment-impacting member purchase system 12 according to the second embodiment described above, and thus descriptions hereafter will be focused on the characteristic functional configuration in the system.

FIG. 2 illustrates a configuration of an environment-impacting member purchase system 13 according to the present embodiment. The environment-impacting member purchase system 13 is the same as the above-described environment-impacting member purchase system 12 excepting for including an environment-impacting member purchase device 103 in place of the environment-impacting member purchase device 102 of the above-described environment-impacting member purchase system 12. It is to be noted that a purchaser system 17 of the environment-impacting member purchase system 13 is the same as the above-described purchaser system 16 excepting for including an environment-impacting member purchase device 103.

A functional configuration of the environment-impacting member purchase device 103 is illustrated in the above-described FIG. 3. The environment-impacting member purchase device 103 is the same as the above-described environment-impacting member purchase device 102 excepting for including a member purchase judging unit 173 in place of the member purchase judging unit 172 of the above-described environment-impacting member purchase device 102.

The member purchase judging unit 173 evaluates to-be-judged details in proposal response information received from a selling-side terminal of a distributor who is a candidate seller based on a criterion specified for each of the judgment items, and, according to the evaluation, narrows down distributors who are the candidates for the seller of the above-described member or determines finally the seller by changing the above-described criterion based on a result of the evaluation.

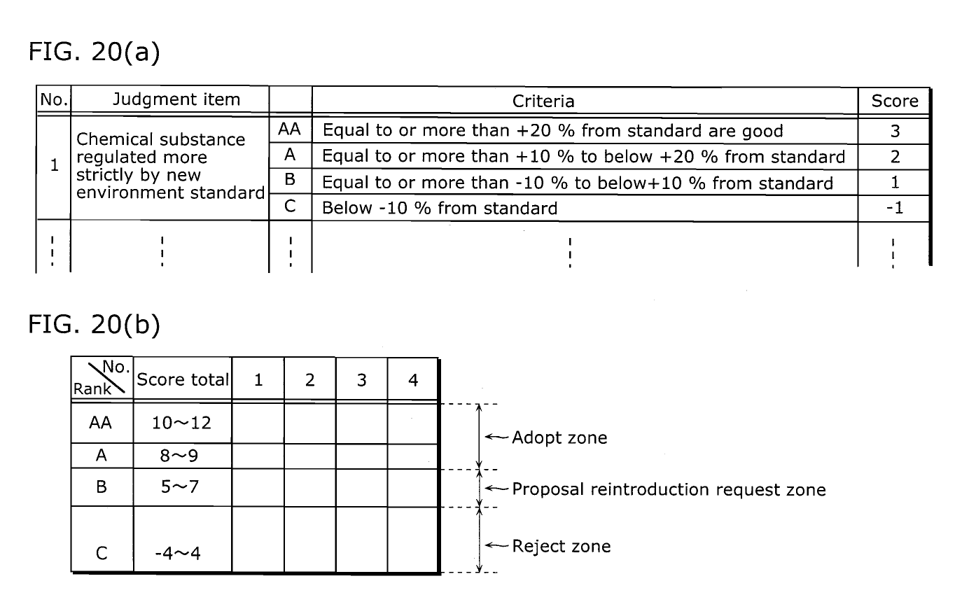

Next, a function of the member purchase judging unit 173 will be descried in detail with reference to FIG. 20. FIG. 20 (a) is a diagram illustrating an example of a changed criterion table that is used when the member purchase judging unit 173 further narrows down the candidate distributors of the member and the like. As illustrated in FIG. 20(a), details of the “criterion” in the above-described FIG. 13(a) is changed in the changed criterion table.

In the case of the judgment item No. 1 “a chemical substance regulated more strictly by the new environment standard”, for example, the criterion of “rank A” is changed from “equal to or more than 0% to less than +20% of the environment standard” to “equal to or more than +10% to less than +20% of the environment standard”, and the criterion of “rank B” is changed from “equal to or more than −10% to less than 0% of the environment standard” to “equal to or more than −10% to less than +10% of the environment standard”, so that candidate distributors for the seller of the member, or distributors to which proposal reintroduction is requested are further narrowed down.

FIG. 20 (b) is a diagram illustrating an example of the evaluation result of the member purchase judging unit 173. In FIG. 20(b), a range of each zone and a value of score total of each rank are changed in response to the change of the criterion in FIG. 20(a) described above.

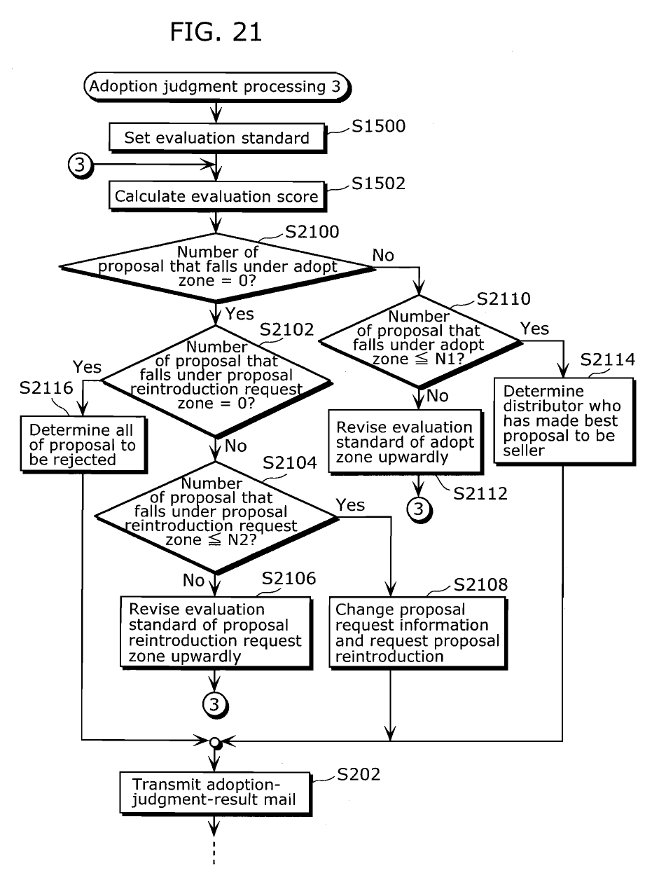

Next, an operational flow in the environment-impacting member purchase device 103 configured as described above will be described with reference to FIG. 21. It is to be noted that the same numerals are applied to the same processes as in the above-described environment-impacting member purchase device 102 according to the second embodiment and the descriptions thereof are omitted.

FIG. 21 is a flowchart illustrating the details of “adoption judgment processing 3” in the environment-impacting member purchase device 103. The “adoption judgment processing 3” is a process performed by the environment-impacting member purchase device 103 in place of “adoption judgment processing 2” in the above-described FIG. 14. It is to be noted that other processes in FIG. 14 are also the same in the present embodiment.

First, the member purchase judging unit 173 of the environment-impacting member purchase device 103 sets an evaluation standard (S1500), evaluates each of the to-be-judged details included in the received proposal response information, and calculates a score (S1502). In the case where a distributor who has made a proposal that falls under the adopt zone exists according to the result (S2100: No) and the number of distributors who have made the proposal that falls under the adopt zone is within “N1” (S2110: Yes), the distributor who has made the best proposal is determined to be a seller (S2114). In the case where the number of distributors who have made a proposal that falls under the adopt zone is more than “N1” (S2110: No), the evaluation standard of the adopt zone is revised upwardly (more specifically, a threshold amount for judging whether or not to belong to the adopt zone is changed to be higher) (S2112), and processes subsequent to the calculation of the evaluation score (S1502) are repeated. Here, “N1” is a numeric value for narrowing down the number of proposals in the case where many proposals that fall under the adopt zone (especially the rank A) are gathered.

On the other hand, in the case where a distributor who has made a proposal that falls under the adopt zone does not exist (S2100: Yes) and a distributor who has made a proposal that falls under the proposal reintroduction request zone does not exist (S2102: Yes), all of the distributors is determined to be rejected (S2116). In the case where a distributor who has made a proposal that falls under the proposal reintroduction request zone exists (S2102: No) and the number of distributors who have made the proposal that falls under the proposal reintroduction request zone is within “N2” (S2104: Yes), the proposal request information is changed and a proposal reintroduction is determined to be requested (S2108). In the case where the number of distributors who have made a proposal that falls under the proposal reintroduction request zone is more than “N2” (S2104: No), the evaluation standard of the proposal reintroduction request zone is revised upwardly (more specifically, a threshold amount for judging whether or not to belong to the proposal reintroduction request zone is changed to be higher) (S2106), and processes subsequent to the calculation of the evaluation score (S1502) are repeated. Here, “N2” is a numeric value for narrowing down the number of proposals in the case where many proposals that fall under the proposal reintroduction request zone are gathered (for example, 10).

As described above, a use of the environment-impacting member purchase system 13 provided with the environment-impacting member purchase device 103 according to the present embodiment makes it possible to more carefully determine, according to the proposal from a distributor of the member, a seller, a receiver of a proposal reintroduction request, or a rejection, even in the case where the environment standard such as the law or the company standard is revised.

It is to be noted that a method by which evaluation is performed by specifying a rank and a score for every judgment item is described in the above-described second and third embodiments, the evaluation is not limited to the above method, and may be performed by weighing for each of the evaluation items. Further, it is also possible to evaluate distributors while maintaining the environment standard of the lowest level by specifying the lowest rank when determining a rank and the like for the judgment item. Further, when evaluating each distributor (determining the adopt zone, the proposal reintroduction request zone, and the reject zone), it is also possible to determine the evaluation for the distributor according to the lowest rank for the judgment item (for example, the distributor is determined to be in the reject zone when at least one C rank judgment item is included, and the like). Further, when determining the distributor to which a proposal reintroduction is requested, a statistical approach such as variance may be used.

Further, in the above-described first to third embodiments, the embodiment that transmits proposal request information from the environment-impacting member purchase device to the purchaser terminal and transmit proposal response information from the purchaser terminal to the environment-impacting member purchase device as a response, the present invention is not limited to this, but proposal request information may be held within the environment-impacting member purchase device, a response to the proposal request information may be made by an access of the purchaser terminal to the environment-impacting member purchase device, and the proposal response information may be generated.

It is to be noted that, although in the environment-impacting member purchase system according to the above-described first to third embodiments, descriptions have been made by assuming the case where a proposal regarding “member” is received mainly from a distributor, it is apparent that the present invention can also be applied to a product made up of plural members.

### INDUSTRIAL APPLICABILITY

The present invention is suitable for a network system for purchasing a member that includes a chemical substance contained in a product and described by the environment standard, and particularly suitable for a purchasing system, a designing system, a manufacturing system, a distribution system, and the like as the system that handles a member used for products by a manufacture.

1. An environment-impacting member purchase device which communicates with a selling-side terminal of a distributor in order to purchase a member containing a chemical substance or an environment-impacting substance that are regulated by an environment standard, said device comprising:
a member specification specifying unit configured to specify a member specification for conforming a member to be purchased to the environment standard;
a request information generating unit configured to generate request information that indicates requesting for a proposal regarding the member by using the specified member specification; and
a proposal request transmission unit configured to transmit the generated proposal request information to the selling-side terminal.

2. The environment-impacting member purchase device according to claim 1, further comprising:
a response information receiving unit configured to receive, from the selling-side terminal, proposal response information that indicates proposal details regarding the member;
a member-purchase judging unit configured to judge whether or not to purchase the member based on the received proposal response information; and
a member-purchase processing unit configured to perform a process for purchasing, with the selling-side terminal, in the case where the member has been judged to be purchased.

3. The environment-impacting member purchase device according to claim 2,
wherein said member-purchase judging unit is further configured to determine, as to the received proposal response information, on one of: purchasing the member; requesting for a proposal reintroduction; and rejection, and
said proposal request transmission unit is further configured to transmit, to the selling-side terminal, information indicating requesting for the proposal reintroduction in the case where said member-purchase judging unit has determined on requesting for the proposal reintroduction.

4. An environment-impacting member purchase system including an environment-impacting member purchase device and a selling-side terminal, for purchasing a member containing a chemical substance or an environment-impacting substance that are regulated by an environment standard, the environment-impacting member purchase device being for a purchaser of the member, the selling-side terminal being for a distributor of the member, and said system comprising:
a target member specifying unit configured to specify a member to be purchased;
a standard information obtainment unit configured to obtain information indicating the environment standard;
a member specification specifying unit configured to specify a member specification for conforming the specified member to be purchased to the environment standard;
a request information generating unit configured to generate, by using the specified member specification, proposal request information that is used for purchasing the member; and
a proposal request transmission unit configured to transmit the generated proposal request information to the selling-side terminal.

5. An environment-impacting member purchase method, for purchasing a member, used in a system that includes an environment-impacting member purchase device of a purchaser of the member and a selling-side terminal of a distributor of the member, the member containing a chemical substance or an environment-impacting substance that are regulated by an environment standard, said method comprising:
specifying a member to be purchased;
obtaining information indicating the environment standard;
specifying a member specification for conforming the specified member to be purchased to the environment standard;
generating, by using the specified member specification, proposal request information that is used for purchasing the member; and
transmitting the generated proposal request information to the selling-side terminal.

6. A program used for an environment-impacting member purchase device which communicates with a selling-side terminal of a distributor in order to purchase a member containing a chemical substance or an environment-impacting substance that are regulated by an environment standard, said program causing a computer to execute:
specifying a member specification for conforming a member to be purchased to the environment standard;
generating request information that indicates requesting for a proposal regarding the member by using the specified member specification; and
transmitting the generated proposal request information to the selling-side terminal.

7. An environment-impacting member purchase device which: narrows down candidates for a seller from which a member or a product is purchased; or determines the seller, the member or the product containing a chemical substance or an environment-impacting substance that are regulated by an environment standard, said device comprising:
a member specification specifying unit configured to specify a member specification for conforming a member to be purchased to the environment standard;
a request information generating unit configured to generate proposal request information that indicates requesting for a proposal regarding the member by using the specified member specification;
a communication control unit configured to transmit the generated proposal request information to a plurality of selling-side terminals, and to receive, from the plurality of selling-side terminals, proposal response information that is a response to the proposal request information, the proposal response information including predetermined to-be-judged details; and
a member-purchase judging unit configured to: evaluate, based on a criterion specified for each of judgment items, the to-be-judged details of the received proposal response information; and narrow down candidates for the seller of the member or determine the seller based on a result of the evaluation.

8. The environment-impacting member purchase device according to claim 7,
wherein said member-purchase judging unit is further configured to: make the proposal response information belong to one of predetermined evaluation zones by using the result of the evaluation; count the number of pieces of proposal response information in the evaluation zones; change the criterion based on a result of the count; and narrow down the candidates for the seller of the member or determine the seller by using the changed criterion.

9. The environment-impacting member purchase device according to claim 8,
wherein the predetermined evaluation zones include an adopt zone, a proposal reintroduction request zone; and a reject zone, and
said member-purchase judging unit is further configured to: make the proposal response information belong to one of the adopt zone, the proposal reintroduction request zone, and the reject zone, by using the result of the evaluation; count the number of pieces of proposal response information in the three zones; change the criterion based on a result of the count; and narrow down the candidates for the seller of the member or determine the seller by using the changed criterion.

10. The environment-impacting member purchase device according to claim 9,
wherein said member-purchase judging unit is further configured to: count the number of pieces of proposal response information belonging to the adopt zone; and change the criterion so that a threshold amount of the criterion for the proposal response information to belong to the adopt zone becomes higher in the case where a result of the count indicates a greater number than a predetermined number.

11. The environment-impacting member purchase device according to claim 9,
wherein said member-purchase judging unit is further configured to: count the number of pieces of proposal response information belonging to the proposal reintroduction request zone; and change the criterion so that a threshold amount of the criterion for the proposal response information to belong to the proposal reintroduction request zone becomes higher in the case where a result of the count indicates a greater number than a predetermined number.

12. A method for purchasing an environment-impacting member, which: narrows down candidates for a seller from which a member or a product is purchased; or determines the seller, the member or the product containing a chemical substance or an environment-impacting substance that are regulated by an environment standard, said method comprising:
specifying member specification for conforming a member to be purchased to the environment standard;
generating proposal request information that indicates requesting for a proposal regarding the member by using the specified member specification;
transmitting the generated proposal request information to a plurality of selling-side terminals, and receiving, from the plurality of selling-side terminals, proposal response information that is a response to the proposal request information, the proposal response information including predetermined to-be-judged details; and
evaluating the to-be-judged details of the received proposal response information based on a criterion specified for each of judgment items; and narrowing down candidates for the seller of the member or determining the seller based on a result of the evaluation.

13. A program used for an environment-impacting member purchase device, said program causing a computer to execute:
specifying member specification for conforming a member to be purchased to the environment standard;
generating proposal request information that indicates requesting for a proposal regarding the member by using the specified member specification;
transmitting the generated proposal request information to a plurality of selling-side terminals, and receiving, from the plurality of selling-side terminals, proposal response information that is a response to the proposal request information, the proposal response information including predetermined to-be-judged details; and
evaluating the to-be-judged details of the received proposal response information based on a criterion specified for each of judgment items; and narrowing down candidates for the seller of the member or determining the seller based on a result of the evaluation.

14. An environment-impacting member purchase system for narrowing down candidates for a seller from which a member or a product is purchased or for determining the seller, the member or the product containing a chemical substance or an environment-impacting substance that are regulated by an environment standard, said system comprising:
an environment-impacting member purchase device of a purchaser of the member or the product; and
a selling-side terminal of a distributor of the member,
wherein said environment-impacting member purchase device includes:
a member specification specifying unit configured to specify a member specification for conforming a member to be purchased to the environment standard;
a request information generating unit configured to generate proposal request information that indicates requesting for a proposal regarding the member by using the specified member specification;
a transmission unit configured to transmit the generated proposal request information to said selling-side terminals;
a receiving unit configured to receive, from said selling-side terminals, proposal response information that is a response to the proposal request information, the proposal response information including predetermined to-be-judged details; and
a member-purchase judging unit configured to: evaluate the to-be-judged details in the received proposal response information based on a criterion specified for each of judgment items; and narrow down candidates for the seller of the member or determine the seller based on a result of the evaluation, and
said selling-side terminal includes a proposal response unit configured to: generate the proposal response information corresponding to the received proposal request information; and transmit the proposal response information to said environment-impacting member purchase device.
